(19) United States
(12) Patent Application Publication
(10) Pub. No.: US 2025/0308199 A1
(43) Pub. Date: Oct. 2, 2025

(54) CALCULATION METHOD, PROJECTION METHOD, AND CONTROL DEVICE

(71) Applicant: SEIKO EPSON CORPORATION, Tokyo (JP)

(72) Inventor: Takumi ARAGAKI, Shiojiri-shi (JP)

(73) Assignee: SEIKO EPSON CORPORATION, Tokyo (JP)

(21) Appl. No.: 19/090,959

(22) Filed: Mar. 26, 2025

(30) Foreign Application Priority Data
Mar. 27, 2024 (JP) 2024-050985

(51) Int. Cl. G06V 10/44; G06T 5/60; G06T 5/80

(52) U.S. Cl. CPC G06V 10/454; G06T 5/60; G06T 5/80

(57) ABSTRACT

A calculation method includes extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, and deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.

The present application is based on, and claims priority from JP Application Serial Number 2024-050985, filed Mar. 27, 2024, the disclosure of which is hereby incorporated by reference herein in its entirety.

### BACKGROUND

### 1. Technical Field

The present disclosure relates to a calculation method, a projection method, and a control device.

### 2. Related Art

In the past, there has been used a technique for calculating a correspondence relationship for each pixel between a plurality of images. For example, JP-A-2023-180611 discloses an environment recognition apparatus including a feature extractor that obtains respective feature maps by performing a convolution operation on both a first image and a second image using the same convolutional neural network, and a matching unit that determines the correspondence relationship between the first image and the second image based on each of the feature maps.

JP-A-2023-180611 is an example of the related art.

However, in the environment recognition apparatus according to JP-A-2023-180611, a single feature extractor executes the convolution operation on both the first image and the second image using the same convolutional neural network. As a result, the correspondence relationship between the first image and the second image determined by the matching unit is low in accuracy.

### SUMMARY

A calculation method according to an aspect of the present disclosure includes extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, and deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.

Further, a projection method according to an aspect of the present disclosure includes extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN, performing a geometric correction on the material image using the corresponding relationship, and making an optical device project a projection image obtained by transforming a coordinate system in the material image on which the geometric correction was performed into a panel coordinate system.

A control device according to an aspect of the present disclosure executes extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, and deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.

### BRIEF DESCRIPTION OF THE DRAWINGS

FIG. 1 is a block diagram showing a configuration of a projection system 1.

FIG. 2 is a block diagram showing a configuration example of a control device 10.

FIG. 3 shows an example of specifications of information input to and output from a matching processor 124.

FIG. 4 is a diagram showing a configuration example in which the matching processor 124 realizes a feature point extraction function and a matching function with a single convolutional neural network (CNN).

FIG. 5 is a diagram showing a configuration example in which a CNN is assigned to each of the feature point extraction function and the matching function in the matching processor 124.

FIG. 6 is a diagram showing a configuration example in which a CNN is assigned to each of the feature point extraction function and the matching function, and further, a network for transmitting a feature of each layer of the CNN realizing the feature point extraction function to an identification layer is added in the matching processor 124.

FIG. 7 is a diagram showing a configuration example in which a learning model for image classification is used for the CNN that realizes the feature point extraction function in the matching processor 124.

FIG. 8 is a diagram showing a configuration example in which a feature pyramid network (FPN) is added to the CNN that realizes the feature point extraction function in the matching processor 124.

FIG. 9 is a diagram showing a configuration example in which a matching network (MMNet) that executes matching processing for each resolution is added to the CNN that realizes the matching function in the matching processor 124.

FIG. 10 is a diagram showing a configuration example in which the CNN that realizes the feature point extraction function includes an attention network in the matching processor 124.

FIG. 11 is a diagram showing a configuration example of the matching processor 124 in the configuration in which the feature point extraction function and the matching function are realized by the single CNN.

FIG. 12 is a diagram showing a configuration example of the matching processor 124 in the configuration in which the CNN is assigned to each of the feature point extraction function and the matching function.

FIG. 13 is a graph showing a relationship between the number of layers of the CNN in the entire matching processor 124 and an average positional deviation.

FIG. 14 is a graph showing a relationship between the number of channels in each intermediate layer in the matching processor 124 and the average positional deviation.

FIG. 15 is a graph showing a relationship between presence or absence and a position of the normalization layer, and the average positional deviation.

FIG. 16 is a graph showing a relationship between a kernel size and the average positional deviation.

FIG. 17 is a diagram showing a configuration example of the matching processor 124 in a configuration in which a network for transmitting the features of the layers to the identification layer is added to the CNN that realizes the feature point extraction function.

FIG. 18 is a diagram showing an algorithm executed by a matching processor 124A according to a first comparative example.

FIG. 19 is a diagram showing an algorithm executed by a matching processor 124B according to a second comparative example.

FIG. 20 is a block diagram showing a configuration example of a projector 20.

FIG. 21 is a flowchart showing overall processing of the control device 10.

FIG. 22 is a flowchart showing matching processing in step S24.

### DESCRIPTION OF EMBODIMENTS

An aspect for implementing the present disclosure will hereinafter be described with reference to the drawings. However, in the drawings, dimensions and scales of the elements are made different from actual ones as appropriate. Further, the following embodiment is preferable specific example of the present disclosure and therefore various technically preferable limitations are imposed thereon, however, the scope of the present disclosure is not limited to the embodiment unless there is a description that the present disclosure is limited thereto in particular in the following description.

### 1: FIRST EMBODIMENT

### 1-1: Configuration of First Embodiment

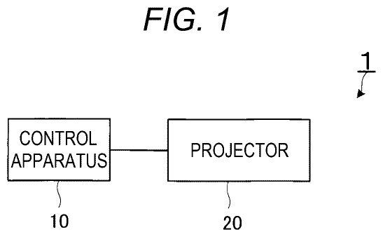

A calculation method and a projection method according to the present embodiment will hereinafter be described with reference to FIGS. 1 to 22.

### 1-1-1: Overall Configuration of Projection System

FIG. 1 is a block diagram illustrating a configuration of a projection system 1 that executes a calculation method and a projection method according to the present embodiment. The projection system 1 includes a control device 10 and a projector 20. The control device 10 and the projector 20 are coupled to each other so as to be able to communicate with each other.

The projector 20 is an apparatus which projects a projection image PI onto an object. The object has a three-dimensional shape. Projection mapping is realized by projecting the projection image PI on a surface of the object. An object image OI representing the object is a monochrome 3D image having a shape of a mannequin wearing clothing. Further, the projection image PI is an image representing an appearance of that clothing.

The control device 10 is a device that controls the projector 20. More specifically, the control device 10 generates the projection image PI described above by performing geometric correction on a material image MI representing the clothing described above and then performing coordinate conversion. Further, the control device 10 makes the projector 20 project the projection image PI thus generated onto the object described above. The material image MI may be an image acquired by the control device 10 from a server via a network, or may be an image stored in a storage device 140 described later.

Therefore, the control device 10 extracts feature points necessary for performing fitting between the object image OI and the material image MI different in appearance from each other. The feature point is, for example, a point representing a change in contour or unevenness of a part constituting each of the object and the material. Further, the control device 10 derives a correspondence relationship between the feature points thus extracted of both the object and the material. The control device 10 performs the geometric correction on the material image MI using that correspondence relationship and converts the coordinate system in the geometrically corrected material image MI into the panel coordinate system of the projector 20 to thereby generate the projection image PI. The coordinate system in the material image MI is a coordinate system for representing coordinates of pixels constituting the material image MI, and the panel coordinate system is a coordinate system for representing coordinates of pixels of a liquid crystal panel provided to the projector 20.

### 1-1-2: CONFIGURATION OF CONTROL DEVICE

### 1-1-2-1: Overall Configuration of Control Device

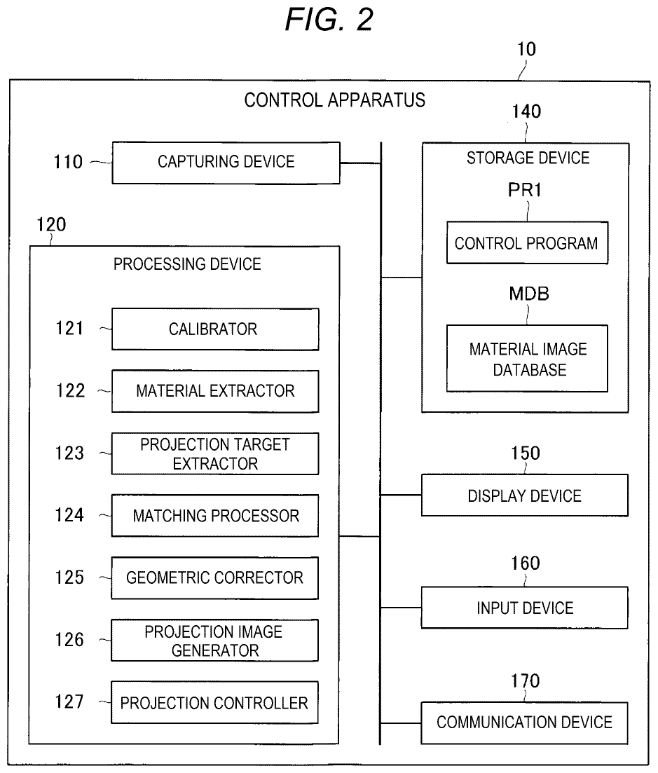

FIG. 2 is a block diagram showing a configuration example of the control device 10. A typical example of the control device 10 is a personal computer (PC), but this is not a limitation, and the control device 10 may be, for example, a tablet terminal or a smartphone. The control device 10 includes a capturing device 110, a processing device 120, the storage device 140, a display device 150, an input device 160, and a communication device 170. Elements of the control device 10 are coupled to each other via a single bus or a plurality of buses for communicating information.

The capturing device 110 is a device that takes an image of an object. The capturing device 110 takes an image of a variety of objects under the control of the processing device 120. For example, a camera provided to the PC, the tablet terminal, or the smartphone is preferably used as the capturing device 110, but this is not a limitation, and an external camera such as a WEB camera may be adopted.

The processing device 120 is a processor that performs overall control of the control device 10 and is configured with, for example, a single chip or a plurality of chips. The processing device 120 is configured with, for example, a central processing unit (CPU) including an interface with a peripheral device, an arithmetic device, a register, and so on. Note that some or all of the functions of the processing device 120 may be implemented by hardware such as a digital signal processor (DSP), an application specific integrated circuit (ASIC), a programmable logic device (PLD), or a field programmable gate array (FPGA). The processing device 120 executes various types of processing in parallel or in sequence.

The storage device 140 is an example of a recording medium which can be read and written by the processing device 120, and stores a plurality of programs including a control program PR1 executed by the processing device 120, and a material image database MDB. The storage device 140 may be configured with at least one of, for example, a read only memory (ROM), an erasable programmable ROM (EPROM), an electrically erasable programmable ROM (EEPROM), and a random access memory (RAM). The storage device 140 may be referred to as a register, a cache, a main memory, a main storage device or the like.

The material image database MDB is a database that stores a first material image MI1. The first material image MI1 is an image serving as a base of the projection image PI to be projected on the object.

The display device 150 is a device that displays an image and character information. The display device 150 may be a display device separated from other elements of the control device 10.

The input device 160 is equipment that receives an operation from a user of the control device 10. The user uses the input device 160 to thereby input the first material image MI1 to be stored in the material image database MDB to the control device 10. The first material image MI1 input by the user is stored in the material image database MDB. For example, the input device 160 is configured including a pointing device such as a keyboard, a touch pad, a touch panel, or a mouse. Here, when the input device 160 is configured including the touch panel, the input device 160 may also serve as the display device 150.

The communication device 170 is hardware serving as a transmitting and receiving device for communicating with other devices. The communication device 170 is also called, for example, a network device, a network controller, a network card, or a communication module. The communication device 170 may include a connector for wired connection and an interface circuit corresponding to the connector. The communication device 170 may include a wireless communication interface. Examples of the connector and the interface circuit for wired connection include those compliant with wired LAN (Local Area Network), IEEE 1394, and a USB (Universal Serial Bus). Further, examples of the wireless communication interface include an interface compliant with wireless LAN and Bluetooth (registered trademark).

The processing device 120 functions as a calibrator 121, a material extractor 122, a projection target extractor 123, a matching processor 124, a geometric corrector 125, a projection image generator 126, and a projection controller 127 by reading the control program PR1 from the storage device 140 and then executing the control program PR1. Note that the control program PR1 may be transmitted from another apparatus such as a server that manages the control device 10 via a communication network.

The calibrator 121 executes calibration processing between the capturing device 110 and the projector 20. When the calibrator 121 executes the calibration processing, a pattern image is projected from the projector 20 onto a screen as an example. As the pattern image, as an example, a pattern image with a gray code or a pattern image in which a grayscale image shaped like a sine curve is used. Subsequently, the capturing device 110 captures the pattern image projected on the screen. The calibrator 121 calculates pixel correspondence information representing a correspondence relationship between pixels of the projector 20 and pixels of the capturing device 110 based on the pattern image projected from the projector 20 and the pattern image captured by the capturing device 110. The calibrator 121 outputs the pixel correspondence information to the projection image generator 126.

Further, the calibrator 121 calculates depth information of a space to be captured by the capturing device 110 based on the pixel correspondence information. The calibrator 121 outputs the depth information to the projection target extractor 123.

Further, the capturing device 110 captures an object which is installed in the space described above and is a target on which the projector 20 projects the projection image PI corresponding to the material image MI as described later. The calibrator 121 outputs a first object image OI1, which is an image of an object captured by the capturing device 110, to the projection target extractor 123.

The material extractor 122 acquires the first material image MI1 from the material image database MDB. In addition, the material extractor 122 removes an image of a background region from the first material image MI1 thus acquired to extract an image of only a region to be mapped to the object described above. The material extractor 122 outputs the second material image MI2 in which only the region to be mapped is extracted to the matching processor 124.

The projection target extractor 123 acquires the first object image OI1 from the calibrator 121. Further, the projection target extractor 123 removes the image of the background region from the first object image OI1 thus acquired, and extracts an image of only the region of the object to be a projection target. The projection target extractor 123 outputs a second object image OI2 in which only the region of the object to be the projection target is extracted to the matching processor 124.

The matching processor 124 extracts a plurality of feature points CP necessary for mapping from each of the second material image MI2 acquired from the material extractor 122 and the second object image OI2 acquired from the projection target extractor 123. Each of the plurality of feature points CP extracted from the second material image MI2 is an example of a first feature point CP1. Each of the plurality of feature points CP extracted from the second object image OI2 is an example of a second feature point CP2. The matching processor 124 generates a first feature map CM1 using the plurality of first feature points CP1. Similarly, the matching processor 124 generates a second feature map CM2 using the plurality of second feature points CP2. Further, the matching processor 124 obtains corresponding point information RI representing a correspondence relationship between corresponding points RP corresponding to each other among the plurality of first feature points CP1 belonging to the first feature map CM1 and the plurality of second feature points CP2 of the second object image OI2 belonging to the second feature map CM2. More specifically, the matching processor 124 derives the corresponding point information RI representing a correspondence relationship between a plurality of first corresponding points RP1 belonging to the plurality of first feature points CP1 and a plurality of second corresponding points RP2 belonging to the plurality of second feature points CP2. The matching processor 124 outputs the corresponding point information RI to the geometric corrector 125.

Note that details of the matching processor 124 will be described later.

The geometric corrector 125 generates a third material image MI3 by performing geometric correction on the second material image MI2 using the corresponding point information RI acquired from the matching processor 124 such that the coordinates of the first corresponding point RP1 of the second material image MI2 and the coordinates of the second corresponding point RP2 of the second object image OI2 coincide with each other. The geometric corrector 125 outputs the third material image MI3 thus generated to the projection image generator 126 as the projection image PI.

The projection image generator 126 converts the coordinate system in the third material image MI3 acquired from the geometric corrector 125 into a panel coordinate system used in the projector 20 based on pixel correspondence information acquired from the calibrator 121 to thereby generate the projection image PI viewed from a projection device 210 described later provided to the projector 20. The projection image generator 126 outputs the projection image PI thus generated to the projection controller 127.

The projection controller 127 makes the projector 20 project the projection image PI acquired from the projection image generator 126 onto the object described above.

### 1-1-2-2: Characteristics of Matching Processor

### A: Input-Output Specification

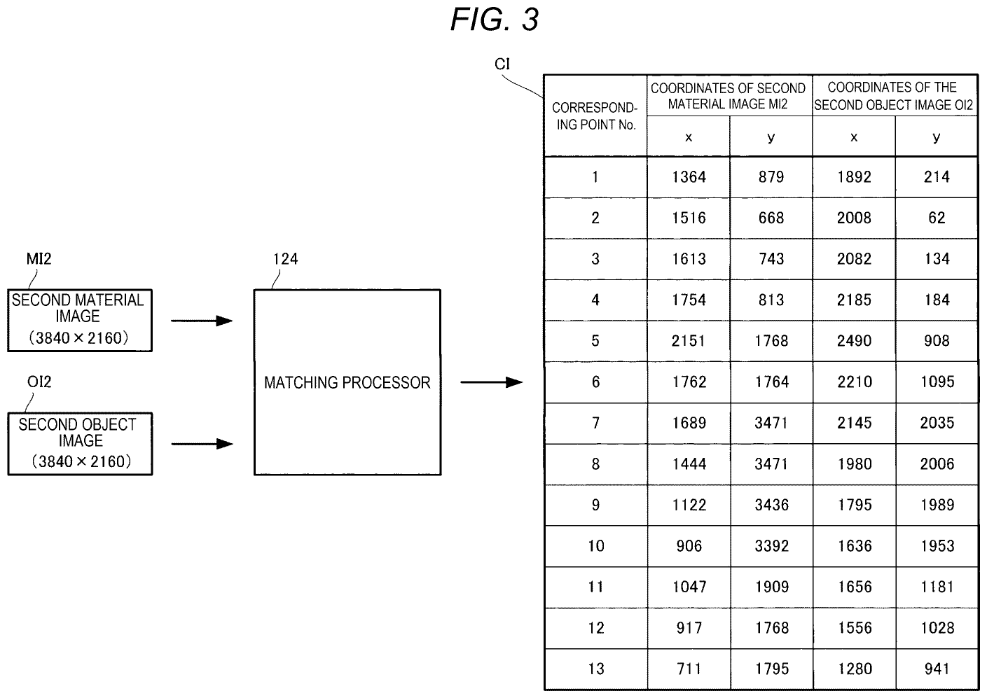

FIG. 3 shows an example of specifications of information input to and output from the matching processor 124. As described above, the second material image MI2 and the second object image OI2 are input to the matching processor 124 as examples of two images different in appearance from each other. As an example, the second material image MI2 and the second object image OI2 are different in at least one of a local shape and a color from each other. Further, as an example, the second material image MI2 and the second object image OI2 are each a color image, a gray image, or an edge image. Further, as an example, the resolution of each of the second material image MI2 and the second object image OI2 is 3840 pixels×2160 pixels. The matching processor 124 extracts the feature points CP necessary for fitting between both images, and then obtains the corresponding point information RI representing the corresponding points RP corresponding to each other. As shown in FIG. 3, the corresponding point information RI is information in which the coordinates of the first corresponding point RP1 belonging to the first feature points CP1 extracted from the second material image MI2 and the coordinates of the second corresponding point RP2 belonging to the second feature points CP2 extracted from the second object image OI2 are associated with each other. Note that in the example shown in FIG. 3, 13 sets of the coordinates of the first corresponding point RP1 belonging to the second material image MI2 and the coordinates of the second corresponding point RP2 belonging to the second object image OI2 are described. However, the number of sets of coordinates of both corresponding points RP may be any number. Note that as a method of extracting the first feature point CP1 and the second feature point CP2 and deriving the corresponding point information RI, deep learning is used. The content of the deep learning will be described later.

### B: Outline of Configuration of Matching Processor

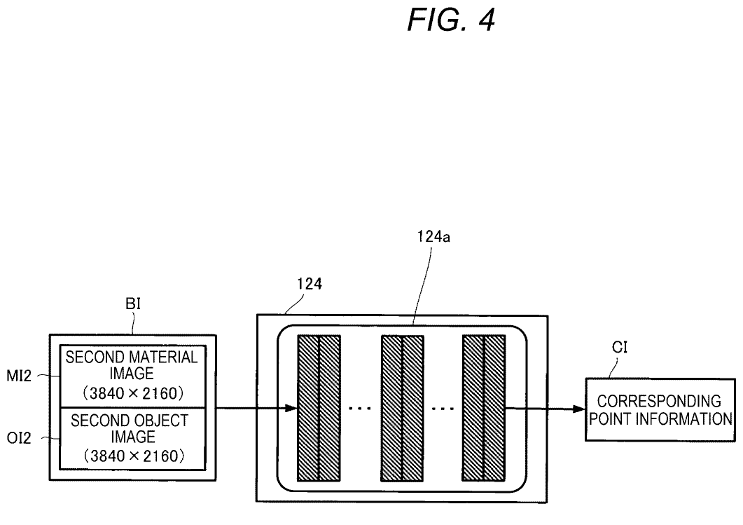

An outline of a configuration of the matching processor 124 will hereinafter be described with reference to FIGS. 4 to 10. Note that in the following description, as the configuration of the matching processor 124, seven configurations will be described, that is, (b1) a configuration in which a feature point extraction function and a matching function are realized by a single convolutional neural network (CNN), (b2) a configuration in which the CNN is assigned to each of the feature point extraction function and the matching function, (b3) a configuration in which a network for transmitting a feature of each layer to an identification layer is added to the CNN that realizes the feature point extraction function, (b4) a configuration in which a learning model for image classification is used in the CNN that realizes the feature point extraction function, (b5) a configuration in which a feature pyramid network (FPN) is added to the CNN that realizes the feature point extraction function, (b6) a configuration in which a multi-scale matching network for each resolution is added to the CNN that realizes the matching function, and (b7) a configuration in which an attention network is added to the CNN that realizes the feature point extraction function. However, these are nothing more than exemplifications of the configuration of the matching processor 124. The matching processor 124 may have a configuration other than the seven configurations described above.

B1: Configuration of Realizing Feature Point Extraction Function and Matching Function with Single CNN

FIG. 4 is a diagram showing a configuration example in which the matching processor 124 realizes the feature point extraction function and the matching function with the single CNN. In FIG. 4, the matching processor 124 includes a single CNN 124a. A combined image BI obtained by combining the second material image MI2 and the second object image OI2 with each other is input to the single CNN 124a. By the single CNN 124a performing a series of convolution operations, the plurality of first feature points CP1 is extracted from the second material image MI2 belonging to the combined image BI, the plurality of second feature points CP2 is extracted from the second object image OI2 belonging to the combined image BI, to derive the corresponding point information RI representing the correspondence relationship between the plurality of first corresponding points RP1 belonging to the plurality of first feature points CP1 and the second corresponding points RP2 belonging to the plurality of second feature points CP2.

Note that the details of the configuration example illustrated in FIG. 4 will be described later in the following section “D: Details of Configuration of Matching Processor”.

### B2: Configuration of Assigning CNNs Respectively to Feature Point Extraction Function and Matching Function

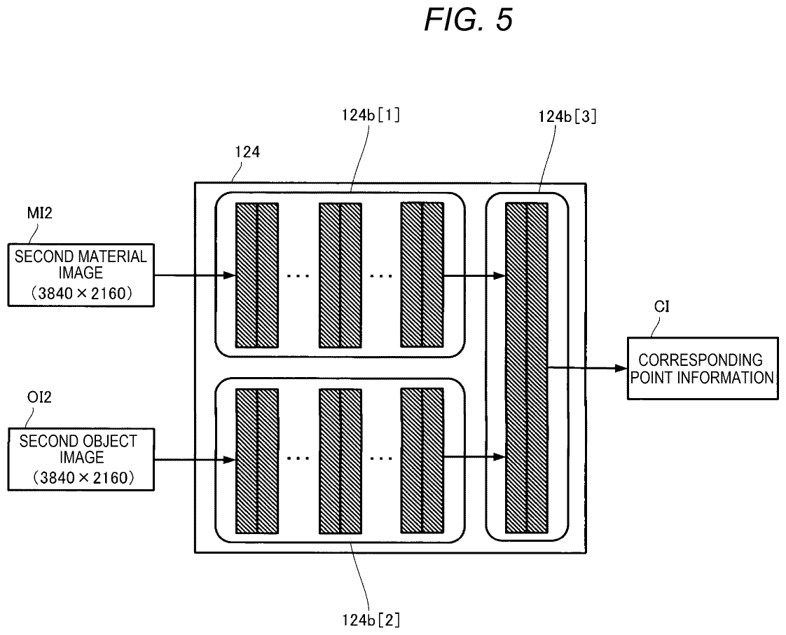

FIG. 5 is a diagram showing a configuration example in which CNNs are assigned respectively to the feature point extraction function and the matching function in the matching processor 124. In FIG. 5, the matching processor 124 includes a first CNN 124b[1], a second CNN 124b[2], and a third CNN 124b[3]. The first CNN 124b [1] extracts the plurality of first feature points CP1 by performing a first convolution operation on the second material image MI2. The second CNN 124b[2] extracts the plurality of second feature points CP2 by performing a second convolution operation on the second object image OI2. The third CNN 124b[3] derives the corresponding point information RI representing a correspondence relationship between the plurality of first corresponding points RP1 belonging to the plurality of first feature points CP1 and the plurality of second corresponding points RP2 belonging to the plurality of second feature points CP2.

By separately providing the first CNN 124b[1] for performing the first convolution operation on the second material image MI2 and the second CNN 124b[2] for performing the second convolution operation on the second object image OI2, the plurality of first feature points CP1 and the plurality of second feature points CP2 are extracted by the respective CNNs different from each other. As a result, the accuracy of the correspondence relationship represented by the corresponding point information RI is improved.

Note that the details of the configuration example illustrated in FIG. 5 will be described later in the following section “D: Details of Configuration of Matching Processor”.

### B3: Configuration of Adding Network of Transmitting Features Of Layers to Identification Layer to CNN Realizing Feature Point Extraction Function

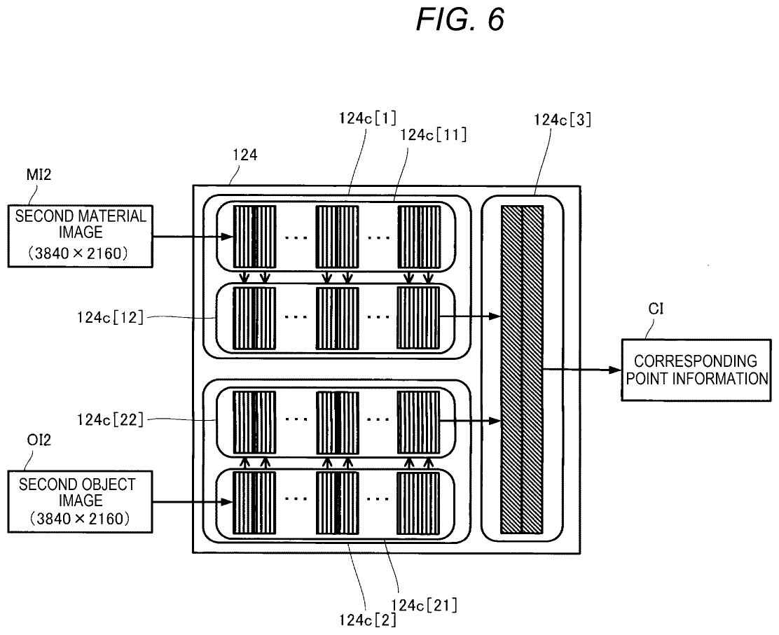

FIG. 6 is a diagram showing a configuration example in which the CNN is assigned to each of the feature point extraction function and the matching function, and further, a network for transmitting a feature of each layer of the CNN realizing the feature point extraction function to an identification layer is added in the matching processor 124. Here, the “identification layer” means the CNN that realizes the matching function. In FIG. 6, the matching processor 124 includes a first CNN 124c[1], a second CNN 124c[2], and a third CNN 124c[3]. The first CNN 124c[1] extracts the plurality of first feature points CP1 by performing the first convolution operation on the second material image MI2. The second CNN 124c[2] extracts the plurality of second feature points CP2 by performing a second convolution operation on the second object image OI2. The third CNN 124c[3] derives the corresponding point information RI representing the correspondence relationship between the plurality of first corresponding points RP1 belonging to the plurality of first feature points CP1 and the plurality of second corresponding points RP2 belonging to the plurality of second feature points CP2.

Further, the first CNN 124c[1] includes a first sub-CNN 124c[11] as a first encoder and a first sub-CNN 124c[12] as a first decoder. The second material image MI2 is input to and encoded by the first sub-CNN 124c[11], and then input to and decoded by the first sub-CNN 124c[12]. In addition, a skip connection of outputting encoded data from one layer belonging to a plurality of layers constituting the first sub-CNN 124c[11] to one layer belonging to a plurality of layers constituting the first sub-CNN 124c[12] is performed.

Since the first CNN 124c[1] includes the first sub-CNN 124c[11] as the first encoder, the first feature map CM1 of the second material image MI2 is encoded, and a reduction in dimension is performed. Further, since the first CNN 124c[1] includes the first sub-CNN 124c[12] as the first decoder, the first feature map CM1 thus encoded is decoded.

Similarly, the second CNN 124c[2] includes a second sub-CNN 124c[21] as a second encoder and a second sub-CNN 124c[22] as a second decoder. The second object image OI2 is input to and encoded by the second sub-CNN 124c[21], and then input to and decoded by the second sub-CNN 124c[22]. In addition, a skip connection of outputting encoded data from one layer belonging to a plurality of layers constituting the second sub-CNN 124c[21] to one layer belonging to a plurality of layers constituting the second sub-CNN 124c[22] is performed.

Since the second CNN 124c[2] includes the second sub-CNN 124c[21] as the second encoder, the second feature map CM2 of the second object image OI2 is encoded, and a reduction in dimension is performed. Further, since the second CNN 124c[2] includes the second sub-CNN 124c[22] as the second decoder, the second feature map CM2 thus encoded is decoded.

When mere classification of the image is performed, there is no particular problem even when the feature map CM in a deep layer is low in resolution. However, when detecting an image or when matching the feature points CP as in the present embodiment, it is a problem that the characteristic map CM in a deep layer is low in resolution. Therefore, when matching the feature points CP, it is necessary to transmit the high-resolution feature maps CM in the shallow layer and the intermediate layer to the identification layer.

In the configuration example described above, each of the first CNN 124c[1] and the second CNN 124c[2] includes the encoder and the decoder. In the encoder, down-sampling of performing a convolution operation and pooling processing on an input image is performed a plurality of times to extract the feature map CM which is low in resolution and unique to the input image. In the decoder, by executing the up-sampling of performing a deconvolution operation a plurality of times, the feature map CM unique to the input image becomes high in resolution. However, when up-sampling is simply performed, the accuracy of the position information of the object belonging to the input image decreases. Therefore, the respective layers of the same scale of the encoder and the decoder are connected by skip connection. As a result, the information of the high-resolution feature map CM from the shallow layer to the intermediate layer at the encoder side is transmitted to the decoder side, and the up-sampling high in accuracy of the position information of the object can be performed. Due to this structure, a low-level feature of the shallow layer (for example, a feature of an edge or the like of an object) and a medium-level feature of the intermediate layer (for example, a feature of a part or the like of an object) are transmitted to the identification layer without losing information of those features themselves and the position information. As a result, the accurate matching of the feature point CP can be achieved.

Note that the details of the configuration example illustrated in FIG. 6 will be described later in the following section “D: Details of Configuration of Matching Processor”.

### B4: Configuration of Using Learning Model for Image Classification in CNN Realizing Feature Point Extraction Function

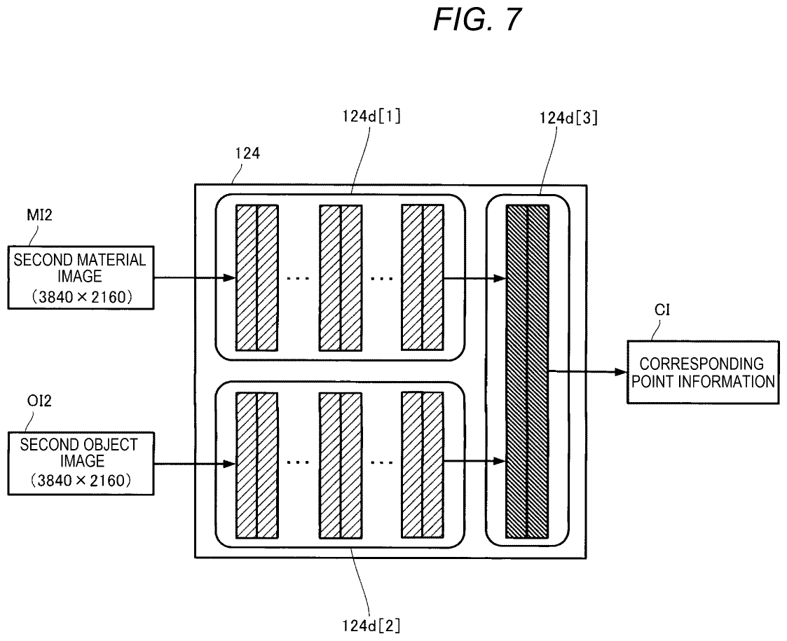

FIG. 7 is a diagram showing a configuration example in which a learning model for image classification is used for the CNN that realizes the feature point extraction function in the matching processor 124. In FIG. 7, the matching processor 124 includes a first CNN 124d[1], a second CNN 124d[2], and a third CNN 124d[3]. The first CNN 124d[1] extracts the plurality of first feature points CP1 by performing the first convolution operation on the second material image M12. The second CNN 124d[2] extracts the plurality of second feature points CP2 by performing the second convolution operation on the second object image OI2. The third CNN 124d[3] derives the corresponding point information RI representing the correspondence relationship between the plurality of first corresponding points RP1 belonging to the plurality of first feature points CP1 and the plurality of second corresponding points RP2 belonging to the plurality of second feature points CP2.

Further, each of the first CNN 124d[1] and the second CNN 124d[2] is a learning model for image classification. As an example, each of the first CNN 124d[1] and the second CNN 124d[2] may be a visual geometry group (VGG) network. More specifically, each of the first CNN 124d[1] and the second CNN 124d[2] may be a 16-layer VGG network or may be a 19-layer VGG network.

The learning model for image classification has already learned features approximate to the features used to extract the feature points CP. By performing additional learning using teacher data in a state in which a learning model for image classification is used as the first CNN 124d[1] and the second CNN 124d[2], it is possible to perform learning with teacher data having a smaller number of data sets than the number of data sets originally required.

### B5: Configuration of Adding Feature Pyramid Network (FPN) to CNN Realizing Feature Point Extraction Function

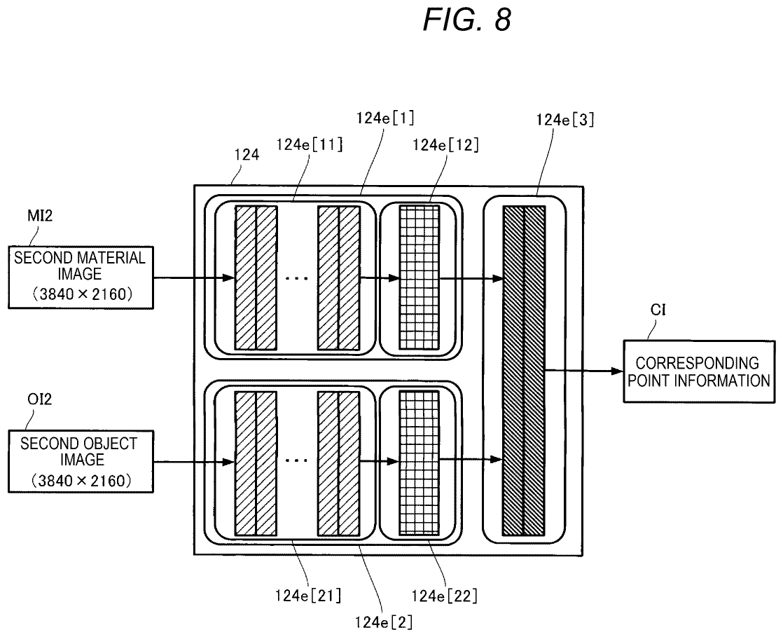

FIG. 8 is a diagram showing a configuration example in which a feature pyramid network (FPN) is added to the CNN that realizes the feature point extraction function in the matching processor 124. The feature pyramid network is a network in which a multi-scale CNN as an encoder is used as a reference structure, and a multi-scale CNN as a decoder is further connected to a latter half of the reference structure in a form of using skip connection for each scale. As a result, the feature pyramid network can learn features of various scales as a result of passing through paths of the various scales. In the present embodiment, the feature pyramid network executes processing of extracting the feature point CP for each resolution. By adding the feature pyramid network to the CNN in the present embodiment, it becomes possible for the CNN to calculate a feature map including all the features of a plurality of image scales, and the robustness increases in an image recognition task that needs to cope with the magnitude of a relative scale variation in an image. As a result, for example, the accuracy in identifying an object having a specific size from a photograph in which objects having various sizes are captured is improved. In FIG. 8, the matching processor 124 includes a first CNN 124e [1], a second CNN 124e [2], and a third CNN 124e[3]. The first CNN 124e[1] extracts the plurality of first feature points CP1 by performing the first convolution operation on the second material image M12. The second CNN 124e[2] extracts the plurality of second feature points CP2 by performing the second convolution operation on the second object image OI2. The third CNN 124e[3] derives the corresponding point information RI representing the correspondence relationship between the plurality of first corresponding points RP1 belonging to the plurality of first feature points CP1 and the plurality of second corresponding points RP2 belonging to the plurality of second feature points CP2.

Further, the first CNN 124e[1] includes a first sub-CNN 124e[11] as the learning model for image classification and a first sub-CNN 124e[12] as the feature pyramid network. When the second material image MI2 is input to the first sub-CNN 124e[11] and is then input to the first sub-CNN 124e[12], the first feature point CP1 is extracted.

Further, the second CNN 124e[2] includes a second sub-CNN 124e[21] as the learning model for image classification and a second sub-CNN 124e[22] as the feature pyramid network. When the second object image OI2 is input to the second sub-CNN 124e[21] and is then input to the second sub-CNN 124e[22], the second feature point CP2 is extracted.

In the first CNN 124e[1], by adding the feature pyramid network posterior to the learning model for image classification, the first CNN 124e[1] can extract the feature point CP for each resolution of the second material image MI2. Further, in the second CNN 124e[2], by adding the feature pyramid network posterior to the learning model for image classification, the second CNN 124e[2] can extract the feature point CP for each resolution of the second object image OI2.

### B6: Configuration of Adding Matching Networks (Multi-Scale Matching Networks) for Respective Resolutions to CNN Realizing Matching Function

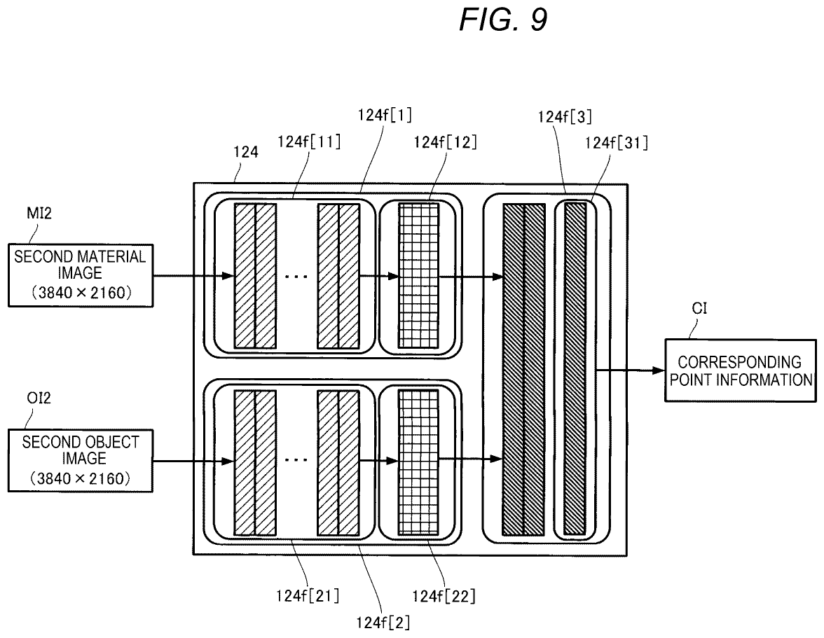

FIG. 9 is a diagram showing a configuration example in which a matching network (MMNet) that executes matching processing for each resolution is added to the CNN that realizes the matching function in the matching processor 124. In FIG. 9, the matching processor 124 includes a first CNN 124f[1], a second CNN 124f[2], and a third CNN 124f[3]. The first CNN 124f[1] extracts the plurality of first feature points CP1 by performing the first convolution operation on the second material image MI2. The second CNN 124f[2] extracts the plurality of second feature points CP2 by performing the second convolution operation on the second object image OI2. The third CNN 124f[3] derives the corresponding point information RI representing the correspondence relationship between the plurality of first corresponding points RP1 belonging to the plurality of first feature points CP1 and the plurality of second corresponding points RP2 belonging to the plurality of second feature points CP2.

Further, the first CNN 124f[1] includes a first sub-CNN 124f[11] as the learning model for image classification and a first sub-CNN 124f[12] as the feature pyramid network. When the second material image MI2 is input to the first sub-CNN 124f[11] and is then input to the first sub-CNN 124f[12], the first feature point CP1 is extracted.

Further, the second CNN 124f[2] includes a second sub-CNN 124f[21] as the learning model for image classification and a second sub-CNN 124f [22] as the feature pyramid network. When the second object image OI2 is input to the second sub-CNN 124f[21] and then input to the second sub-CNN 124f[22], the second feature point CP2 is extracted.

Further, the third CNN 124f[3] includes a matching network 124f[31] for each resolution. Since the third CNN 124f[3] includes the matching network 124f[31], the matching processing is executed for each resolution of the second material image MI2 input to the first CNN 124f[1] and for each resolution of the second object image OI2 input to the second CNN 124f [2]. Since the third CNN 124f [3] includes the matching network 124f[31] for each resolution, as an example, the third CNN 124f[3] directly up-samples the matching result of the previous scale and combines the result of the up-sampling with the details of the current matching to learn a complementary correspondence relationship between the scales.

### B7: Configuration of Providing Attention Network to CNN Realizing Feature Point Extraction Function

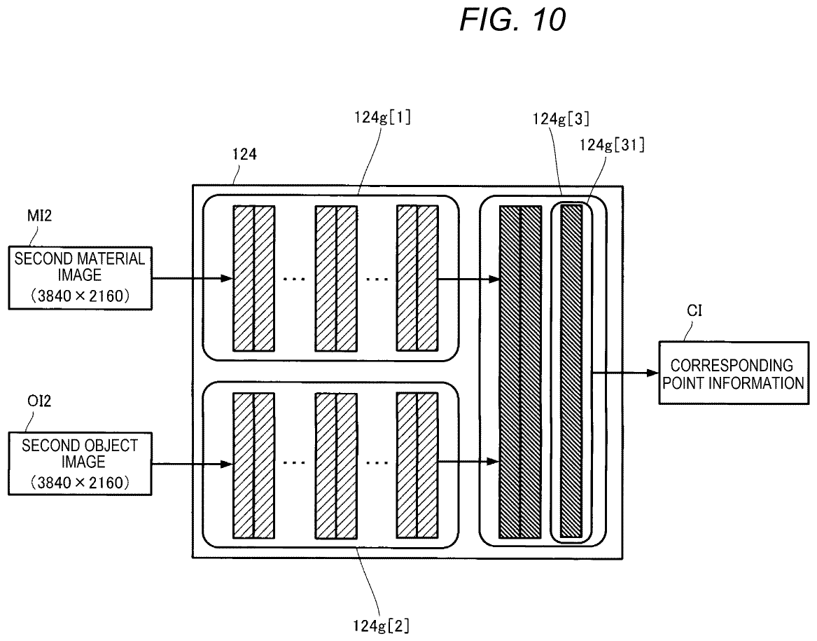

FIG. 10 is a diagram showing a configuration example in which the CNN that realizes the feature point extraction function includes an attention network in the matching processor 124. The attention network is a network for dynamically specifying to which part of input data attention should be paid. As an example, in the image recognition, it is possible for the CNN including the attention network to remove the background unrelated to the recognition and further perform learning paying attention only to a foreground. In FIG. 10, the matching processor 124 includes a first CNN 124g[1], a second CNN 124g[2], and a third CNN 124g[3]. The first CNN 124g[1] extracts the plurality of first feature points CP1 by performing the first convolution operation on the second material image MI2. The second CNN 124g[2] extracts the plurality of second feature points CP2 by performing the second convolution operation on the second object image OI2. The third CNN 124g[3] derives the corresponding point information RI representing the correspondence relationship between the plurality of first corresponding points RP1 belonging to the plurality of first feature points CP1 and the plurality of second corresponding points RP2 belonging to the plurality of second feature points CP2.

Further, each of the first CNN 124g[1] and the second CNN 124g[2] includes the attention network. Since the first CNN 124g[1] includes the attention network, it is possible to perform learning in a state where the background region is removed from the material image MI as the teacher data. In addition, since the second CNN 124g[2] includes the attention network, it is possible to perform learning in a state where the background region is removed from the object image OI as the teacher data.

Further, the third CNN 124g[3] includes a matching network 124g[31] for each resolution. Since the third CNN 124g[3] includes the matching network 124g[31], the matching processing is executed for each resolution of the second material image MI2 input to the first CNN 124g[1] and for each resolution of the second object image OI2 input to the second CNN 124g[2].

### C: Method of Generating Learning Data Set and Model Resolution

The teacher data of the CNN realizing the matching function described above will hereinafter be described citing when adopting “(b2) the configuration in which the CNNs are assigned respectively to the feature point extraction function and the matching function” described above as an example for the sake of simplification of explanation.

In the present embodiment, the third CNN 124b[3] learns the correspondence relationship between the plurality of first corresponding points RP1 for learning and the plurality of second corresponding points RP2 for learning as the teacher data in the learning stage. The plurality of first corresponding points RP1 for learning belongs to the plurality of first feature points CP1 for learning. The plurality of first feature points CP1 for learning are extracted by inputting the material image MI of the second resolution obtained by reducing the material image MI of the first resolution at a predetermined reduction ratio to the first CNN 124b[1]. The plurality of second corresponding points RP2 for learning belongs to the plurality of second feature points CP2 for learning. The plurality of second feature points CP2 for learning is extracted by inputting the object image OI of the second resolution obtained by reducing the object image OI of the first resolution at a predetermined reduction ratio to the second CNN 124b[2]. Here, the first resolution is higher than the second resolution.

Further, in the operation stage, the second material image MI2 of the second resolution is input to the first CNN 124b[1], and the second object image OI2 of the second resolution is input to the second CNN 124b[2].

When generating the data set, as an example, the operator first prepares an original image of 2160 pixels×3840 pixels. For example, the operator prepares 74 original images of 2160 pixels×3840 pixels as the material images MI and 24 original images of 2160 pixels×3840 pixels as the object images OI. Then, the operator visually sets the positions of the coordinates of the feature points CP with respect to these images. At this stage, the position of the coordinates of the feature point CP is represented by a numerical value of pixel. The numerical value is an integer.

Then, the operator performs reduction processing on the original images to the respective magnifications. As an example, the operator generates an image obtained by reducing the original image to a half in the horizontal direction and a half in the vertical direction, an image obtained by reducing the original image to a half in the horizontal direction and a fourth in the vertical direction, an image obtained by reducing the original image to a fourth in the horizontal direction and an eighth in the vertical direction, and an image obtained by reducing the original image to an eighth in the horizontal direction and a sixteenth in the vertical direction. In these images, the position of the coordinates of the feature point CP is represented by a decimal according to the reduction ratio.

Finally, the operator creates a total of 1008 data sets as teacher data by combining the 56 material images MI and the 18 object images OI for each resolution. More specifically, as an example, the operator picks up 56 material images MI from the 74 material images MI as the original images, picks up 18 object images OI from the 24 object images OI as the original images, and combines these images to thereby generate a total of 1008 data sets as the teacher data. In these data sets, the position of the coordinates of the feature point CP is represented by a decimal according to the reduction ratio similarly to the above.

The third CNN 124b[3] includes a learning model that learns using, as teacher data, data sets including combinations of the material images MI in which the position of the coordinates of the first feature point CP1 is represented by a decimal and the object images OI in which the position of the coordinates of the second feature point CP2 is represented by a decimal. On the other hand, in the operation stage, the position of the coordinates of the first feature point CP1 of the second material image MI2 and the position of the coordinates of the second feature point CP2 of the second object image OI2 input to the third CNN 124b[3] are represented by integers. In addition, the resolution of the original images of the material image MI and the object image OI used in the data set as the teacher data is higher than the resolution of the second material image MI2 input to the first CNN 124b[1] and the resolution of the second object image OI2 input to the second CNN 124b[2] in the operation stage. Therefore, the third CNN 124b[3] can generate a highly accurate correspondence relationship. That is, instead of using the high-resolution second material image MI2 and the object image OI as teacher data as they are, the resolutions of the second material image MI2 and the object image OI are pseudo-converted to low resolutions at a predetermined reduction ratio, and a learning model is constructed by the pseudo-low-resolution second material image MI2 and the object image OI. As a result, the learning model outputs the coordinates of the first feature point CP1 and the coordinates of the second feature point CP2 in decimal form, which can be expressed only by integers in the related art, so that it is possible to improve the accuracy of the correspondence relationship.

Note that the lower the reduction ratio of the material image MI and the object image OI used in the data sets of the teacher data is, the more the number of data sets required for learning and the learning time increase. Therefore, in practice, matching can be executed with higher accuracy as the third CNN 124b[3] uses, as teacher data, the data sets generated using the combination of the material image MI and the object image OI reduced to a smaller size at a reduction ratio equal to or higher than a predetermined value.

Note that in the above description, when there is adopted “(b2) the configuration in which the CNN is assigned to each of the feature point extraction function and the matching function” is described as an example, but the same applies to other cases, that is, when there is adopted “(b3) the configuration in which the network for transmitting the feature of each layer to the identification layer is added to the CNN realizing the feature point extraction function”, when there is adopted “(b4) the configuration in which a learning model for image classification is used in the CNN realizing the feature point extraction function”, when there is adopted “(b5) the configuration in which the feature pyramid network (FPN) is added to the CNN realizing the feature point extraction function”, when there is adopted “(b6) the configuration in which the matching network (MMNet) for each resolution is added to the CNN realizing the matching function”, and when there is adopted “(b7) the configuration in which the attention network is added to the CNN realizing the feature point extraction function”.

### D: Details of Configuration of Matching Processor

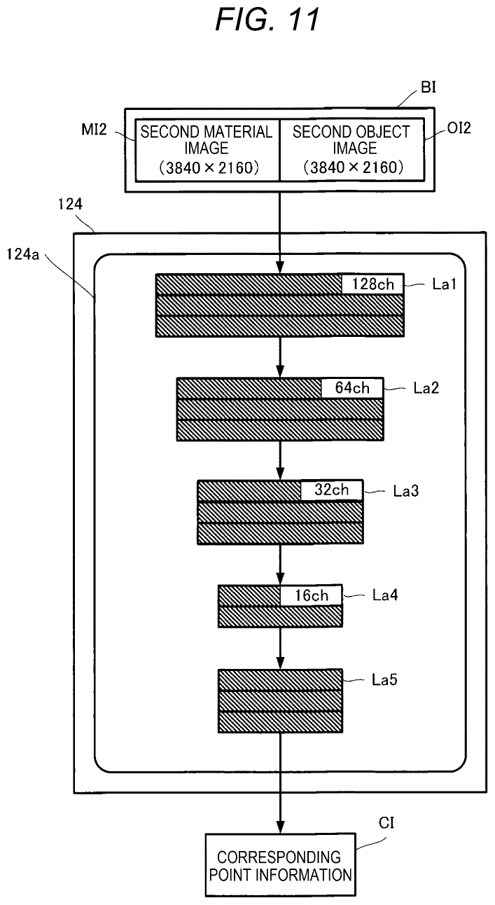

The details of the configuration of the matching processor 124 will hereinafter be described with reference to FIGS. 11 to 17. Note that details of “(b1) the configuration in which the feature point extraction function and the matching function are realized by a single convolutional neural network (CNN)”, “(b2) the configuration in which the CNN is assigned to each of the feature point extraction function and the matching function”, and “(b3) the configuration in which a network for transmitting the feature of each layer to the identification layer is added to the CNN that realizes the feature point extraction function” described above will hereinafter be described.

Further, in the following, the details of the elements and hyper-parameters of “(b2) the configuration of assigning the CNN to each of the feature point extraction function and the matching function” will be mainly examined together with the verification result.

D1: Configuration of Realizing Feature Point Extraction Function and Matching Function with Single CNN

FIG. 11 is a diagram showing a configuration example of the matching processor 124 in the configuration in which the feature point extraction function and the matching function are realized by the single CNN.

The matching processor 124 in the present configuration example includes the CNN 124a as described above. The combined image BI obtained by combining the second material image MI2 and the second object image OI2 is input to the CNN 124a. Further, when each of the blocks constituting the CNN 124a is counted as one layer, the CNN 124a has a five-layer structure of a first layer La1 to a fifth layer La5 as illustrated in FIG. 11. The number of channels of the convolutional layer belonging to the first layer La1 is 128. The number of channels of the convolutional layer belonging to the second layer La2 is 64. The number of channels of the convolutional layer belonging to the third layer La3 is 32. The number of channels of the convolutional layer belonging to the fourth layer La4 is 16. As described above, in the CNN 124a, the number of channels in each convolutional layer decreases continuously or stepwise from the input-side convolutional layer toward the output-side convolutional layer. That is, in the CNN 124a, the number of channels of the output-side convolutional layer is smaller than the number of channels of the input-side convolutional layer.

Note that these numbers of channels are illustrative only. Further, these numbers of channels are each a multiple of each of the number of first corresponding points RP1 and the number of second corresponding points RP2 belonging to the corresponding point information RI output from the CNN 124a.

As described above, the CNN 124a has a five-layer structure, and the number of channels in each of the convolutional layers decreases continuously or stepwise from the input-side convolutional layer toward the output-side convolutional layer.

### D2: Configuration of Assigning CNNs Respectively to Feature Point Extraction Function and Matching Function

### D2-1: Details of Configuration

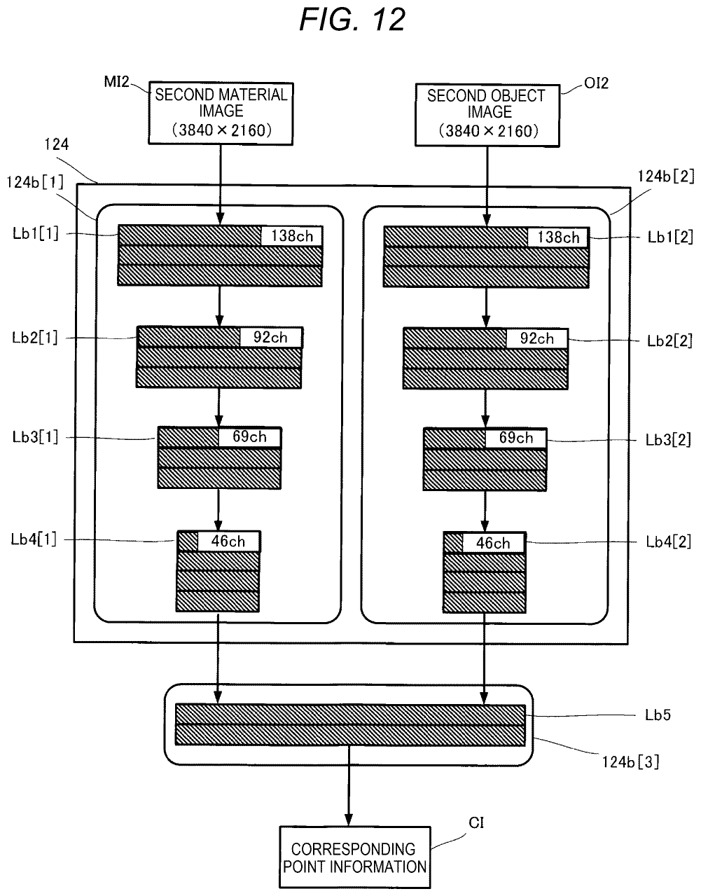

FIG. 12 is a diagram illustrating a configuration example of the matching processor 124 in a configuration in which the CNNs are assigned respectively to the feature point extraction function and the matching function.

As described above, the matching processor 124 in the present configuration example includes the first CNN 124b[1], the second CNN 124b[2], and the third CNN 124b[3]. The second material image M12 is input to the first CNN 124b[1]. The second object image OI2 is input to the second CNN 124b[2].

Further, when each of the blocks constituting the first CNN 124b[1] is counted as one layer, the first CNN 124b[1] has a four-layer structure of a first layer Lb1[1] to a fourth layer Lb4 [1] as illustrated in FIG. 12. The number of channels of the convolutional layer belonging to the first layer Lb1 [1] is 138. The number of channels of the convolutional layer belonging to the second layer Lb2[1] is 92. The number of channels of the convolutional layer belonging to the third layer Lb3[1] is 69. The number of channels of the convolutional layer belonging to the fourth layer Lb4 [1] is 46. As described above, in the first CNN 124b[1], the number of channels in each convolutional layer decreases continuously or stepwise from the input-side convolutional layer toward the output-side convolutional layer. That is, in the first CNN 124b[1], the number of channels of the output-side convolutional layer is smaller than the number of channels of the input-side convolutional layer.

Note that these numbers of channels are illustrative only. These numbers of channels are multiples of the number of first corresponding points RP1 belonging to the corresponding point information RI output from the third CNN 124b[3].

Further, when each of the blocks constituting the second CNN 124b[2] is counted as one layer, the second CNN 124b[2] has a four-layer structure of a first layer Lb1[2] to a fourth layer Lb4[2] as illustrated in FIG. 12. The number of channels of the convolutional layer belonging to the first layer Lb1[2] is 138. The number of channels of the convolutional layer belonging to the second layer Lb2[2] is 92. The number of channels of the convolutional layer belonging to the third layer Lb3[2] is 69. The number of channels of the convolutional layer belonging to the fourth layer Lb4[2] is 46. As described above, in the second CNN 124b[2], the number of channels in each convolutional layer decreases continuously or stepwise from the input-side convolutional layer toward the output-side convolutional layer. That is, in the second CNN 124b[2], the number of channels of the output-side convolutional layer is smaller than the number of channels of the input-side convolutional layer.

Note that these numbers of channels are illustrative only. These numbers of channels are multiples of the number of second corresponding points RP2 belonging to the corresponding point information RI output from the third CNN 124b[3].

Further, when each of the blocks constituting the third CNN 124b[3] is counted as one layer, the third CNN 124b[3] has a one-layer structure of the fifth layer Lb5 as shown in FIG. 12.

That is, the CNN as a whole of the matching processor 124 has a five-layer structure.

In addition, the normalization layer is applied only immediately after the input layer (not illustrated in FIG. 12) provided to each of the first CNN 124b[1] and the second CNN 124b[2].

Note that it is preferable to reduce the kernel size, which is one of the hyper-parameters used in the matching processor 124, and instead, increase the number of layers in the entire CNN as a whole of the matching processor 124.

Further, when the details of the configuration of the matching processor 124 are optimized, it is preferable that the dropout is executed last. When the hyper-parameters used in the matching processor 124 are optimized, it is preferable that regularization processing is executed last.

Further, the activation function of the output layer belonging to the third CNN 124b[3] is preferably ReLu (max=n) instead of Linear which is common. Note here that “n” is the maximum value of the resolution of the second material image MI2 input to the first CNN 124b[1] and is the maximum value of the resolution of the second object image OI2 input to the second CNN 124b[2] in the operation stage.

### D2-2: Examination Content

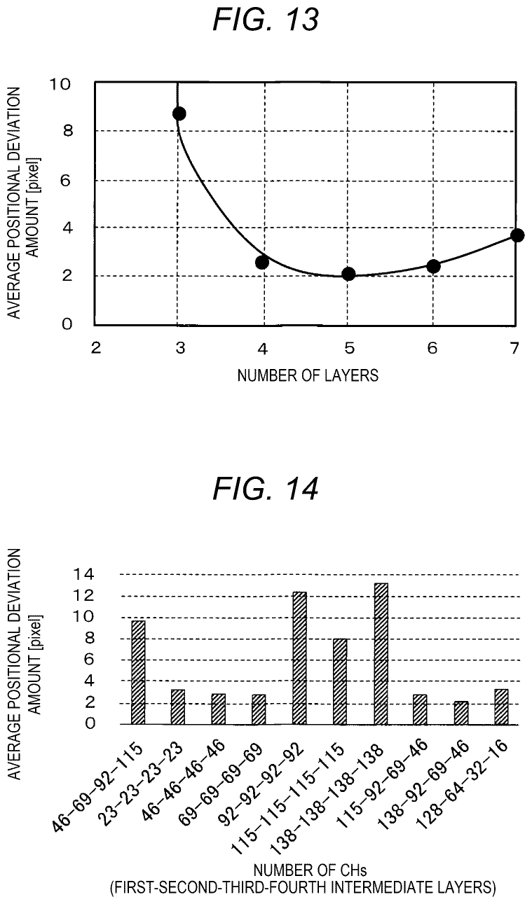

The reason why the setting contents described above are set regarding a part of the details of the configuration in which the CNNs are assigned respectively to the feature point extraction function and the matching function and a part of the hyper-parameters will hereinafter be described with reference to FIGS. 13 to 16. Note that in the examination, the operator input the second material image MI2 of 256 pixels×256 pixels to the first CNN 124b[1], and input the second object image OI2 of 256 pixels×256 pixels to the second CNN 124b[2].

Subsequently, an average positional deviation amount (hereinafter referred to as an “average positional deviation amount”) between correct values determined by visual observation of the feature point positions of the second material image MI2 and the second object image OI2 and estimated values of the feature point positions when the control device 10 superimposed the second material image MI2 on the second object image OI2 was used as a measure of the accuracy of the matching processor 124.

More specifically, the following items were examined by using, as test data, 7104 data sets corresponding to 20% of 35520 data sets in total, which are combinations of 74 material images MI as the original images and 480 images obtained by performing 20-time data extension on the 24 object images OI as the original images, to the control device 10.

### D2-2-1: Number of Layers

FIG. 13 is a graph illustrating a relationship between the number of layers of the CNN in the entire matching processor 124 and the average positional deviation. The horizontal axis represents the number of layers of the CNN. Further, the vertical axis represents the average positional deviation amount. As illustrated in FIG. 13, when the number of layers of the CNN was five, the average positional deviation amount was minimum. In determining the number of layers of the CNN, since the policy of setting the maximum number of layers as long as the performance was improved while increasing the number of layers from two layers was adopted, the number of layers of the CNN in the entire matching processor 124 was set to five as described above.

### D2-2-2: Number of Channels

FIG. 14 is a graph showing a relationship between the number of channels in each intermediate layer in the matching processor 124 and the average positional deviation. The horizontal axis represents the number of channels in each of the intermediate layers. Each item on the horizontal axis is a combination of four numbers. The four numbers represent the number of channels of a first layer, the number of channels of a second layer, the number of channels of a third layer, and the number of channels of a fourth layer, respectively from the left. The vertical axis represents the average positional deviation amount. Out of the combinations of the numbers of channels shown in FIG. 14, the average positional deviation amount was minimized when the combination of the number of channels of the first layer, the number of channels of the second layer, the number of channels of the third layer, and the number of channels of the fourth layer was a combination of 138 channels, 92 channels, 69 channels, and 46 channels. As shown in FIG. 14, it was shown that a configuration in which the number of channels was set large in the first layer of the intermediate layers and was decreased toward the last layer was preferable.

### D2-2-3: Normalization Layer

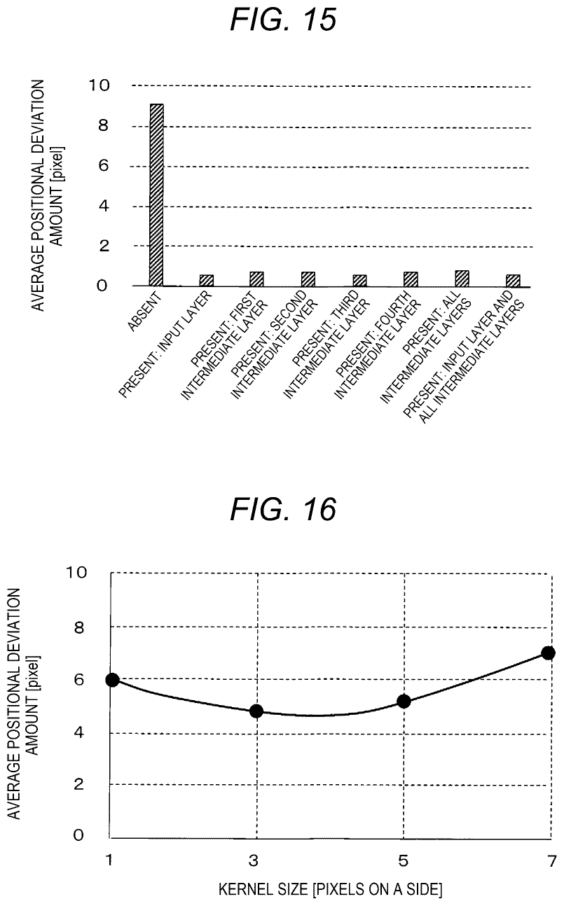

FIG. 15 is a graph illustrating a relationship between presence or absence and a position of a normalization layer, and the average positional deviation. The horizontal axis represents the presence or absence and the position of the normalization layer. Further, the vertical axis represents the average positional deviation amount. As illustrated in FIG. 15, when the normalization layer was disposed only immediately after the input layer, the average positional deviation amount was minimized.

### D2-2-4: Kernel Size

FIG. 16 is a graph showing a relationship between a kernel size and the average positional deviation. The horizontal axis represents the length of each of a vertical side and a horizontal side of a square kernel. Further, the vertical axis represents the average positional deviation amount. As illustrated in FIG. 15, when the kernel size was 3 pixels×3 pixels, the average positional deviation amount was minimized.

### D3: Configuration of Adding Network of Transmitting Features Of Layers to Identification Layer to CNN Realizing Feature Point Extraction Function

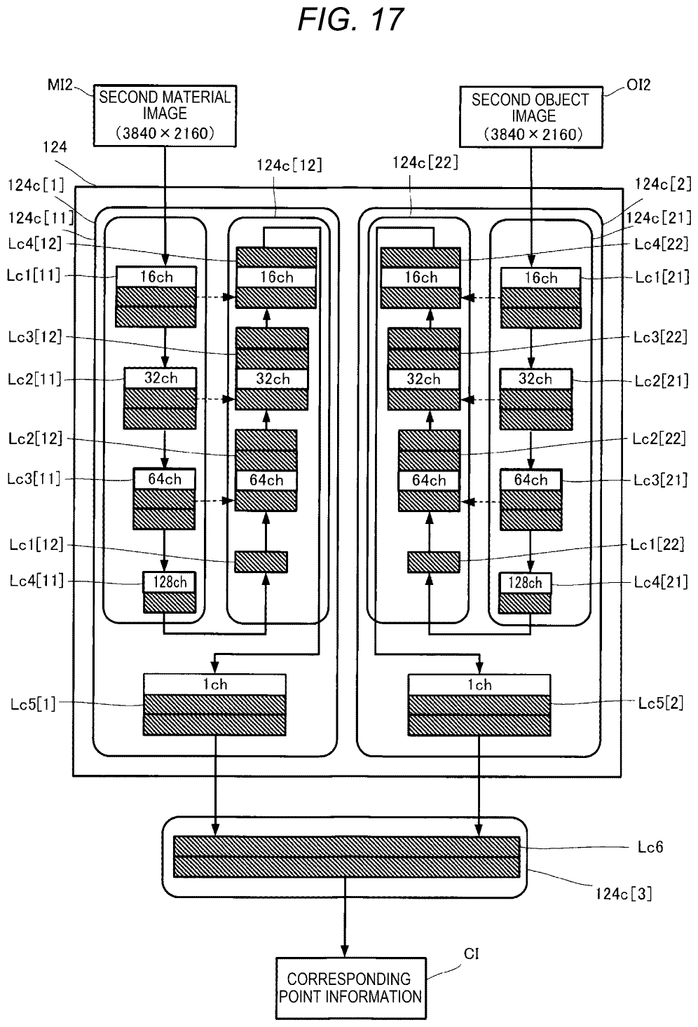

FIG. 17 is a diagram showing a configuration example of the matching processor 124 in a configuration in which a network for transmitting the features of the layers to the identification layer is added to the CNN that realizes the feature point extraction function.

As described above, the matching processor 124 in the present configuration example includes the first CNN 124c[1], the second CNN 124c[2], and the third CNN 124c[3]. The second material image MI2 is input to the first CNN 124c[1]. The second object image OI2 is input to the second CNN 124c[2].

Further, as described above, the first CNN 124c[1] includes the first sub-CNN 124c[11] as the first encoder and the first sub-CNN 124c[12] as the first decoder. The second material image MI2 is input to and encoded by the first sub-CNN 124c[11], and then input to and decoded by the first sub-CNN 124c[12].

Further, when each of the blocks constituting the first sub-CNN 124c[11] is counted as one layer, the first sub-CNN 124c[11] has a four-layer structure of a first layer Lc1[11] to a fourth layer Lc4[11] as shown in FIG. 17. The number of channels of the convolutional layer belonging to the first layer Lc1[11] is 16. The number of channels of the convolutional layer belonging to the second layer Lc2[11] is 32. The number of channels of the convolutional layer belonging to the third layer Lc3[11] is 64. The number of channels of the convolutional layer belonging to the fourth layer Lc4 [11] is 128. As described above, in the first sub-CNN 124c[11], the number of channels in each convolutional layer increases continuously or stepwise from the input-side convolutional layer toward the output-side convolutional layer.

Further, when each of the blocks constituting the first sub-CNN 124c[12] is counted as one layer, the first sub-CNN 124c[12] has a four-layer structure of a first layer Lc1[12] to a fourth layer Lc4[12] as shown in FIG. 17. The number of channels of the convolutional layer belonging to the second layer Lc2[12] is 64. The number of channels of the convolutional layer belonging to the third layer Lc3[12] is 32. The number of channels of the convolutional layer belonging to the fourth layer Lc4[12] is 16. As described above, in the first sub-CNN 124c[12], the number of channels in each convolutional layer decreases continuously or stepwise from the input-side convolutional layer toward the output-side convolutional layer. That is, in the first sub-CNN 124c[12], the number of channels of the output-side convolutional layer is smaller than the number of channels of the input-side convolutional layer.

The first CNN 124c[1] includes a fifth layer Lc5[1] as an additional block. The second material image MI2 is input to the first sub-CNN 124c[11] as the first encoder. The information output from the first sub-CNN 124c[11] is input to the first sub-CNN 124c[12] as the first decoder. The information output from the first sub-CNN 124c[12] is input to the fifth layer Lc5 [1]. The first feature map CM1 including the first feature points CP1 is output from the fifth layer Lc5[1]. Note that the number of channels of the convolutional layer belonging to the fifth layer Lc5[1] is one.

Further, in the first CNN 124c[1], a skip connection is made from the first layer Lc1[11] of the first sub-CNN 124c[11] to the fourth layer Lc4[12] of the first sub-CNN 124c[12]. The information encoded by the first layer Lc1[11] is output to the fourth layer Lc4[12] and decoded by the fourth layer Lc4[12].

Further, a skip connection is made from the second layer Lc2[11] of the first sub-CNN 124c[11] to the third layer Lc3[12] of the first sub-CNN 124c[12]. The information encoded by the second layer Lc2 [11] is output to the third layer Lc3[12] and decoded by the third layer Lc3[12].

In addition, a skip connection is made from the third layer Lc3[11] of the first sub-CNN 124c[11] to the second layer Lc2[12] of the first sub-CNN 124c[12]. The information encoded by the third layer Lc3 [11] is output to the second layer Lc2[12] and decoded by the second layer Lc2[12].

Further, the second CNN 124c[2] includes the second sub-CNN 124c[21] as the second encoder and the second sub-CNN 124c[22] as the second decoder. The second object image OI2 is input to and encoded by the second sub-CNN 124c [21], and then input to and decoded by the second sub-CNN 124c[22].

Further, when each of the blocks constituting the second sub-CNN 124c[21] is counted as one layer, the second sub-CNN 124c[21] has a four-layer structure of a first layer Lc1[21] to a fourth layer Lc4[21] as shown in FIG. 17. The number of channels of the convolutional layer belonging to the first layer Lc1[21] is 16. The number of channels of the convolutional layer belonging to the second layer Lc2 [21] is 32. The number of channels of the convolutional layer belonging to the third layer Lc3[21] is 64. The number of channels of the convolutional layer belonging to the fourth layer Lc4[21] is 128. As described above, in the second sub-CNN 124c[21], the number of channels in each convolutional layer increases continuously or stepwise from the input-side convolutional layer toward the output-side convolutional layer.

Further, when each of the blocks constituting the second sub-CNN 124c[22] is counted as one layer, the second sub-CNN 124c[22] has a four-layer structure of a first layer Lc1[22] to a fourth layer Lc4[22] as shown in FIG. 17. The number of channels of the convolutional layer belonging to the second layer Lc2[22] is 64. The number of channels of the convolutional layer belonging to the third layer Lc3[22] is 32. The number of channels of the convolutional layer belonging to the fourth layer Lc4[22] is 16. As described above, in the second sub-CNN 124c[22], the number of channels in each convolutional layer decreases continuously or stepwise from the input-side convolutional layer toward the output-side convolutional layer. That is, in the second sub-CNN 124c[22], the number of channels of the output-side convolutional layer is smaller than the number of channels of the input-side convolutional layer.

The second CNN 124c[2] includes a fifth layer Lc5[2] as an additional block. The second object image OI2 is input to the second sub-CNN 124c[21] as the second encoder. The information output from the second sub-CNN 124c[21] is input to the second sub-CNN 124c[22] as the second decoder. The information output from the second sub-CNN 124c[22] is input to the fifth layer Lc5[2]. The second feature point CP2 is output from the fifth layer Lc5 [2]. The number of channels of the convolutional layer belonging to the fifth layer Lc5[2] is one.

Further, in the second CNN 124c[2], a skip connection is made from the first layer Lc1 [21] of the second sub-CNN 124c[21] to the fourth layer Lc4[22] of the second sub-CNN 124c[22]. The information encoded by the first layer Lc1[21] is output to the fourth layer Lc4[22] and decoded by the fourth layer Lc4[22].

In addition, a skip connection is made from the second layer Lc2[21] of the second sub-CNN 124c[21] to the third layer Lc3[22] of the second sub-CNN 124c[22]. The information encoded by the second layer Lc2 [21] is output to the third layer Lc3[22] and decoded by the third layer Lc3[22].

In addition, a skip connection is made from the third layer Lc3[21] of the second sub-CNN 124c[21] to the second layer Lc2 [22] of the second sub-CNN 124c[22]. The information encoded by the third layer Lc3 [21] is output to the second layer Lc2[22] and decoded by the second layer Lc2[22].

Further, when each of the blocks constituting the third CNN 124c[3] is counted as one layer, the third CNN 124c[3] has a one-layer structure of the sixth layer Lc6 as shown in FIG. 17.

That is, the CNN as a whole of the matching processor 124 has a six-layer structure.

### E: Data Extension

As a measure which improves the matching accuracy by the matching processor 124, and which is related to environmental robustness, it is preferable to increase the number of data sets of the teacher data used at the time of learning of the CNN provided to the matching processor 124 so that mapping can be performed at high speed on various mapping targets in various environments. As an example, 10,000 first object images OI1 to be used as the teacher data can be generated from one first object image OI1 and a plurality of mask images for masking the first object image OI1.

Specifically, it is preferable to perform the data extension by generating images while changing a relative positional relationship between an object belonging to the first object image OI1 as the mapping target and a camera, a local shape of that object, exposure of the camera, contrast of the camera, white balance of the camera, modulation transfer function (MTF) characteristics of the camera, brightness of illumination, and environmental variation factors including a background of that object in a space in which that object is installed. As an example, it is possible to perform the data extension by generating various images while replacing the background of the object in the first object image OI1 with a background image such as a plain, a group of buildings, or mountains. Note that the “relative positional relationship” includes a relative relationship related to at least one of a relative horizontal position between the object and the camera, a relative vertical position between the object and the camera, a relative position in a depth direction between the object and the camera (a degree of enlargement or reduction of an image captured by the camera), and a rotation angle about a Roll axis of the camera with respect to the object.

Further, when the number of data sets of the teacher data is increased while changing the local shape of the object described above, highly accurate matching is possible even when the object described above is an elastic body.

In addition, when increasing the data sets of the teacher data while changing the environmental variation factors described above, when performing the data extension by synthesizing various backgrounds after performing the affine transformation for changing the relative positional relationship between the object and the camera, and finally changing the luminance of the image, the variations of the combination in geometric transformation between the background and the object increases compared to when changing the luminance of the image after synthesizing the background and finally performing the affine transformation, and therefore, the highly accurate matching can be performed. Alternatively, the affine transformation may be performed on the image of the object to change the shape of that object, the affine transformation may be performed on the background image to change the shape of that background image, and then the image of the object changed in shape and the background image changed in shape may be combined with each other.

In addition, when the background image is synthesized, by providing a halftone in the vicinity of the boundary between the object and the background in accordance with the area of the background, the boundary position at the sub-pixel accuracy can be reproduced in a pseudo manner, and highly accurate matching can be performed.

In addition, images captured by commercially available cameras may have various aspect ratios. By executing the data extension after a margin is inserted into the first object image OI1 in order to realize robust estimation with respect to an image having any aspect ratio, highly accurate matching is possible. As an example, when the first object image OI1 of 2656 pixels×3984 pixels is changed to a square image of 3984 pixels×3984 pixels, then reduced to an image of 1288 pixels×28 pixels, and is changed to an image of 2048 pixels×2048 pixels by inserting a margin, and is further reduced to an image of 256 pixels×256 pixels, the highly accurate matching becomes possible regardless of the aspect ratio of the image.

The same applies to the data extension with respect to the first material image MI1.

It is preferable to increase the number of data sets by changing the combination of the first material image Mi1 and the first object image OI1 in the data sets as the teacher data on that basis.

### 1-1-3: COMPARATIVE EXAMPLES

### 1-1-3-1: First Comparative Example

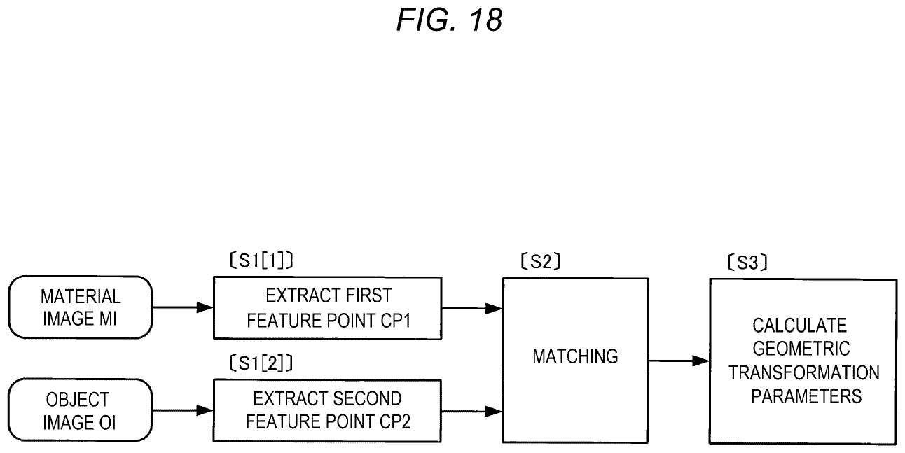

FIG. 18 is a diagram showing an algorithm executed by a matching processor 124A according to a first comparative example. The matching processor 124A executes matching processing with a single geometric-matching CNN (GMC).

Specifically, as illustrated in FIG. 18, the matching processor 124A extracts the first feature points CP1, which are the feature points CP of the material image MI in step S1 [1]. In addition, in step S1 [2] parallel to step S1 [1], the matching processor 124A extracts the second feature points CP2 that are the feature points CP of the object image OI. Further, in step S2, the matching processor 124A executes matching between the first feature points CP1 and the second feature points CP2. Further, in step S3, the matching processor 124A calculates parameters in the geometric transformation.

However, the accuracy of the alignment executed by the matching processor 124A is lower than the accuracy of the alignment executed by the matching processor 124 according to the present disclosure. This is because the data used in the matching processing is the deepest layer data obtained by performing the Max Pooling processing four times, and the spatial resolution is 1/16, so that the estimation accuracy of the positions of the corresponding points RP is low.

### 1-1-3-2: Second Comparative Example

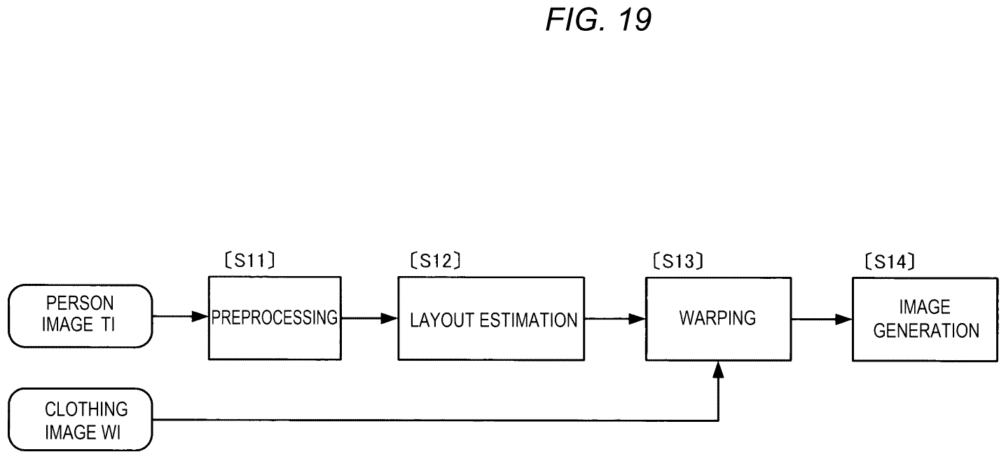

FIG. 19 is a diagram illustrating an algorithm executed by a matching processor 124B according to the second comparative example. The matching processor 124B executes matching processing with a parse free appearance flow network (PF-AFN).

Specifically, as illustrated in FIG. 19, in step S11, the matching processor 124B executes preprocessing. Specifically, the matching processor 124B estimates, from a person image TI, a pose of a person represented by the person image TI, which parts correspond to parts constituting the person in the person image TI, and a processing target region in the person image TI. In step S12, the matching processor 124B executes layout estimation. Specifically, the matching processor 124B estimates a layout when clothing represented by a clothing image WI is worn by the person represented by the person image TI. In step S13, the matching processor 124B executes warping. Specifically, the matching processor 124B deforms the clothing image WI so as to achieve a target layout. In step S14, the matching processor 124B executes image generation. Specifically, the matching processor 124B generates an image in which the person represented by the person image TI wears clothes represented by the clothing image WI.

However, the matching processor 124B can generate only an image in which the person represented by the person image TI wears outer clothes represented by the clothing image WI. In other words, the matching processor 124B can use only an image of the outer clothes as the clothing image WI. This is because what the matching processor 124B executes is segmentation processing specialized for outer clothes. Therefore, unlike the matching processor 124 according to the present disclosure, the matching processor 124B cannot be applied to a target other than the outer clothes.

### 1-2: Configuration of Projector

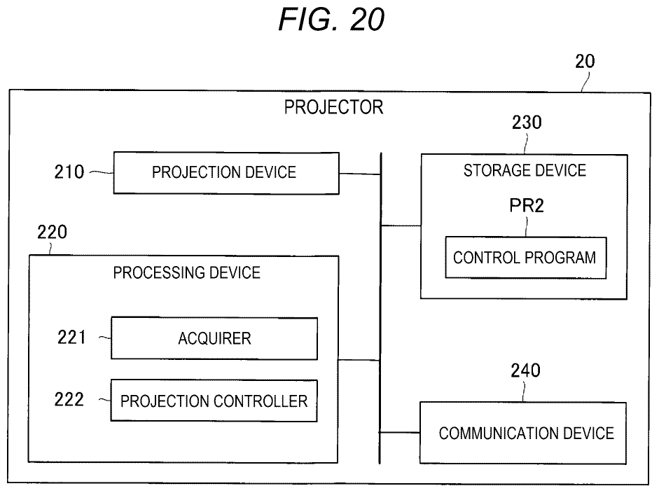

FIG. 20 is a block diagram showing a configuration example of the projector 20. The projector 20 includes a projection device 210, a processing device 220, a storage device 230, and a communication device 240. Elements of the projector 20 are coupled to each other with a single bus or a plurality of buses for communicating information. Further, each element of the projector 20 may include a single device or a plurality of devices, and some of the elements of the projector 20 may be omitted.

The projection device 210 is a device that projects an image represented by an image signal acquired by an acquirer 221 described later on a screen, a wall, or the like. The projection device 210 projects various images under the control of the processing device 220. The projection device 210 includes, for example, a light source, a liquid crystal panel, and a projection lens, modulates light from the light source using the liquid crystal panel, and projects the light thus modulated onto the screen, the wall, or the like via the projection lens.

The processing device 220 is a processor that performs overall control of the projector 20, and includes, for example, a single chip or a plurality of chips. The processing device 220 includes, for example, a central processing unit (CPU) including an interface with a peripheral device, an arithmetic device, a register, and so on. Note that some or all of the functions of the processing device 220 may be realized by hardware such as a DSP, an ASIC, a PLD, or an FPGA. The processing device 220 executes various types of processing in parallel or in sequence.

The storage device 230 is a recording medium which can be read by the processing device 220 and stores a plurality of programs including a control program PR2 to be executed by the processing device 220. The storage device 230 may include at least one of, for example, a ROM, an EPROM, an EEPROM, and a RAM. The storage device 230 may be referred to as a register, a cache, a main memory, a main storage device, or the like.

The communication device 240 is hardware serving as a transmitting and receiving device for communicating with other devices. The communication device 240 is also called, for example, a network device, a network controller, a network card, or a communication module. The communication device 240 may include a connector for wired connection and an interface circuit compatible with the connector. Further, the communication device 240 may include a wireless communication interface. Examples of the connector for wired connection and the interface circuit include those compliant with wired LAN, IEEE 1394, and USB. Further, examples of the wireless communication interface include an interface compliant with wireless LAN and Bluetooth (registered trademark).

The processing device 220 functions as the acquirer 221 and the projection controller 222 by reading the control program PR2 out from the storage device 230 and then executing the control program PR2. Noe that the control program PR2 may be transmitted from another device such as a server that manages the projector 20 via a communication network.

The acquirer 221 acquires an image signal corresponding to the projection image PI and a control signal for controlling the projector 20 from the control device 10.

The projection controller 222 makes the projection device 210 project the projection image PI corresponding to the image signal acquired by the acquirer 221 onto the object based on the control signal acquired by the acquirer 221.

Note that in the present embodiment, the projection device 210 is an example of an “optical device”. Further, the projector 20 is another example of the “optical device”.

### 1-3: OPERATION OF CONTROL DEVICE

### 1-3-1: Overall Processing of Control Device

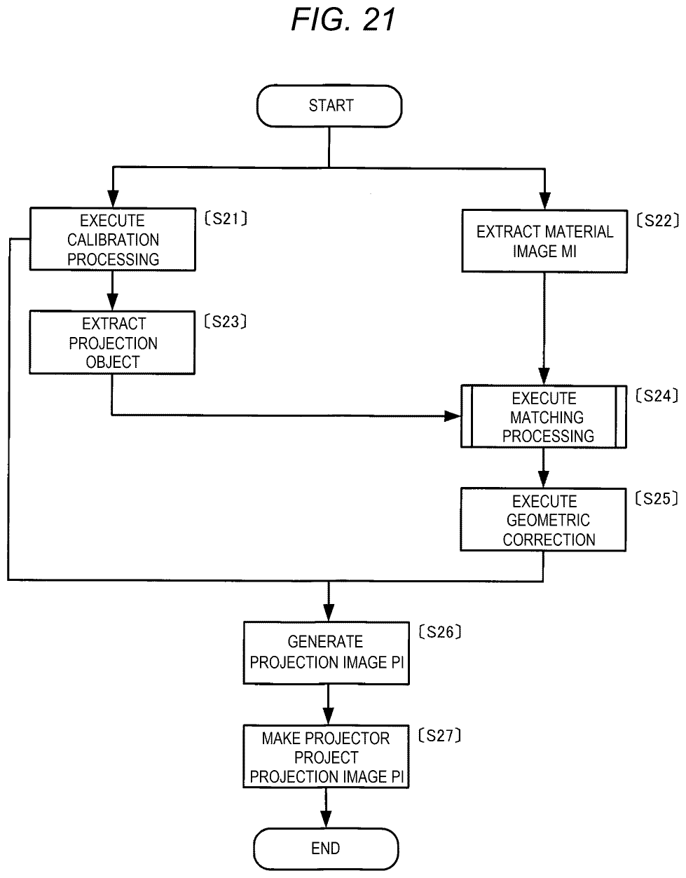

FIG. 21 is a flowchart showing overall processing of the control device 10.

In step S21, the processing device 120 functions as the calibrator 121. The processing device 120 executes calibration processing between the capturing device 110 and the projector 20. Specifically, the processing device 120 calculates pixel correspondence information representing a correspondence relationship between pixels of the projector 20 and pixels of the capturing device 110 based on the pattern image projected from the projector 20 and the pattern image captured by the capturing device 110. Further, the processing device 120 calculates depth information of a space to be captured by the capturing device 110 based on the pixel correspondence information.

In step S22, the processing device 120 functions as the material extractor 122. The processing device 120 acquires the first material image MI1 from the material image database MDB. Further, the processing device 120 removes the image of the background region from the first material image MI1 thus acquired to generate a second material image MI2 in which only the region to be mapped to the object is extracted.

In step S23, the processing device 120 functions as the projection target extractor 123. The processing device 120 removes the image of the background region from the first object image OI1 to generate the second object image OI2 in which only the region of the object to be the projection target is extracted.

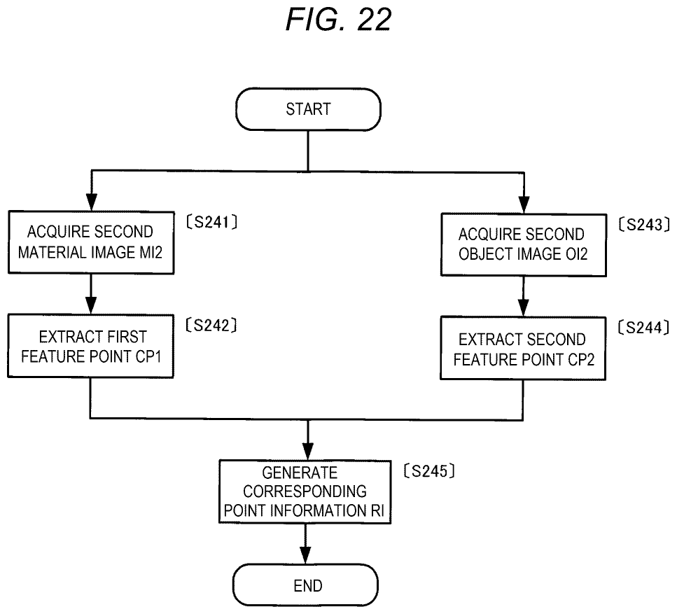

In step S24, the processing device 120 functions as the matching processor 124. The processing device 120 extracts the first feature points CP1 from the second material image MI2. Further, the processing device 120 extracts the second feature points CP2 from the second object image OI2. Further, the processing device 120 generates the corresponding point information RI representing the correspondence relationship between the first corresponding points RP1 belonging to the first feature points CP1 and the second corresponding points RP2 belonging to the second feature points CP2. Note that details of step S24 will be described later with reference to FIG. 22.

In step S25, the processing device 120 functions as the geometric corrector 125. The processing device 120 generates the third material image MI3 by performing geometric correction on the second material image MI2 using the corresponding point information RI such that the coordinates of the first corresponding points RP1 of the second material image MI2 and the coordinates of the second corresponding points RP2 of the second object image OI2 coincide with each other.

In step S26, the processing device 120 functions as the projection image generator 126. The processing device 120 converts the coordinate system in the third material image MI3 into the panel coordinate system used in the projector 20 based on the pixel correspondence information to thereby generate the projection image PI viewed from the projection device 210 provided to the projector 20.

In step S27, the processing device 120 functions as the projection controller 127. The processing device 120 makes the projector 20 project the projection image PI onto the object.

### 1-3-2: MATCHING PROCESSING

FIG. 22 is a flowchart showing matching processing in step S24 described above.

In sub-step S241, the processing device 120 acquires the second material image MI2.

In sub-step S242, the processing device 120 extracts a plurality of first feature points CP1 necessary for mapping from the second material image MI2. Further, the processing device 120 generates the first feature map CM1 using the plurality of first feature points CP1.

In sub-step S243, the processing device 120 acquires the second object image OI2.

In sub-step S244, the processing device 120 extracts a plurality of second feature points CP2 necessary for mapping from the second object image OI2. Further, the processing device 120 generates the second feature map CM2 using the plurality of second feature points CP2.

In sub-step S245, the processing device 120 generates the corresponding point information RI representing the correspondence relationship between the corresponding points RP corresponding to each other among the plurality of first feature points CP1 belonging to the first feature map CM1 and the plurality of second feature points CP2 of the second object image OI2 belonging to the second feature map CM2.

### 2. SUMMARY OF PRESENT DISCLOSURE

The summary of the present disclosure will hereinafter be appended.

(Appendix 1) A calculation method including extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, and deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.

By separately providing the first CNN for performing the first convolution operation on the second material image MI2 and the second CNN for performing the second convolution operation on the second object image OI2, the plurality of first feature points and the plurality of second feature points are extracted by the respective CNNs different from each other. As a result, the accuracy of the correspondence relationship represented by the corresponding point information RI is improved.

(Appendix 2) The calculation method described in Appendix 1, wherein the third CNN includes a learning model that learned, as teacher data, a correspondence relationship between a first corresponding point for learning belonging to the plurality of first feature points extracted by inputting a material image of a second resolution obtained by reducing a material image of a first resolution to the first CNN, and a second corresponding point for learning belonging to the plurality of second feature points extracted by inputting an object image of the second resolution obtained by reducing an object image of the first resolution to the second CNN.

The third CNN includes a learning model that learned using, as teacher data, data sets including combinations of the material images MI in which the position of the coordinates of the first feature point is represented by a decimal and the object images in which the position of the coordinates of the second feature point is represented by a decimal. Accordingly, for example, when the material image and the object image of the second resolution are input to the learning model, the learning model can output both the position of the coordinates of the first feature point and the position of the coordinates of the second feature point as a decimal. That is, the calculation method in Appendix 2 can generate a highly accurate correspondence relationship including a decimal number.

(Appendix 3) The calculation method described in Appendix 1 or 2, wherein a number of channels of the first CNN decreases continuously or stepwise from an input-side convolutional layer toward an output-side convolutional layer, and a number of channels of the second CNN decreases continuously or stepwise from an input-side convolutional layer toward an output-side convolutional layer.

This makes it possible for the third CNN to generate a highly accurate correspondence relationship.

(Appendix 4) A projection method including extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN, performing a geometric correction on the material image using the corresponding relationship, and making an optical device project a projection image obtained by transforming a coordinate system in the material image on which the geometric correction was performed into a panel coordinate system.

By separately providing the first CNN for performing the first convolution operation on the second material image and the second CNN for performing the second convolution operation on the second object image, the plurality of first feature points and the plurality of second feature points are extracted by the respective CNNs different from each other. As a result, the projection system 1 can execute highly accurate matching.

(Appendix 5) A control device configured to execute extracting a plurality of first feature points by performing a first convolution operation on a material image which is input to a first CNN, and which is to be projected onto an object, extracting a plurality of second feature points by performing a second convolution operation on an object image which is input to a second CNN, and which includes the object, and deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.

By separately providing the first CNN for performing the first convolution operation on the second material image MI2 and the second CNN for performing the second convolution operation on the second object image OI2, the plurality of first feature points and the plurality of second feature points are extracted by the respective CNNs different from each other. As a result, the accuracy of the correspondence relationship represented by the corresponding point information RI is improved.

What is claimed is:

1. A calculation method comprising:
extracting a plurality of first feature points by performing a first convolution operation on a material image which is input to a first CNN, and which is to be projected onto an object;
extracting a plurality of second feature points by performing a second convolution operation on an object image which is input to a second CNN, and which includes the object; and
deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.

2. The calculation method according to claim 1, wherein
the third CNN includes a learning model that learned, as teacher data, a correspondence relationship between
a first corresponding point for learning belonging to the plurality of first feature points extracted by inputting a material image of a second resolution obtained by reducing a material image of a first resolution to the first CNN, and
a second corresponding point for learning belonging to the plurality of second feature points extracted by inputting an object image of the second resolution obtained by reducing an object image of the first resolution to the second CNN.

3. The calculation method according to claim 1, wherein
a number of channels of the first CNN decreases continuously or stepwise from an input-side convolutional layer toward an output-side convolutional layer, and
a number of channels of the second CNN decreases continuously or stepwise from an input-side convolutional layer toward an output-side convolutional layer.

4. A projection method comprising:
extracting a plurality of first feature points by performing a first convolution operation on a material image which is input to a first CNN, and which is to be projected onto an object,
extracting a plurality of second feature points by performing a second convolution operation on an object image which is input to a second CNN, and which includes the object,
deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN,
performing a geometric correction on the material image using the corresponding relationship, and
causing an optical device project a projection image obtained by transforming a coordinate system in the material image on which the geometric correction was performed into a panel coordinate system.

5. A control device configured to execute:
extracting a plurality of first feature points by performing a first convolution operation on a material image which is input to a first CNN, and which is to be projected onto an object;
extracting a plurality of second feature points by performing a second convolution operation on an object image which is input to a second CNN, and which includes the object; and
deriving a correspondence relationship between a plurality of first corresponding points and a plurality of second corresponding points by performing a third convolution operation on the plurality of first corresponding points belonging to the plurality of first feature points input to a third CNN, and on the plurality of second corresponding points belonging to the plurality of second feature points input to the third CNN.
